(19) United States
(12) Patent Application Publication
(10) Pub. No.: US 2026/0367585 A1
(43) Pub. Date: Nov. 19, 2026

(54) METHOD AND MACHINE CONTROLLER FOR CONTROLLING A MACHINE

(71) Applicant: Siemens Aktiengesellschaft, München (DE)

(72) Inventor: Phillip Swazinna, Neufahrn (DE)

(21) Appl. No.: 19/132,435

(22) PCT Filed: Oct. 18, 2023
(86) PCT No.: PCT/EP2023/079058

§ 371 Date: May 23, 2025

(30) Foreign Application Priority Data
Nov. 25, 2022 (EP) 22209688.5

(51) Int. Cl. G05B 13/02

(52) U.S. Cl. CPC G05B 13/0265

(57) ABSTRACT

A multiplicity of training datasets. Each specify a machine state, a control action and a resulting subsequent state. For a respective machine state, a training action trajectory is derived, an action trajectory is predicted by a control agent and a divergence of the predicted action trajectory from the training action trajectory is determined. The divergence is accumulated over multiple trajectory time steps. The control agent is then trained to reduce the determined divergences. In addition, a performance evaluator is provided that determines a trajectory performance value for an action trajectory. A multiplicity of test action trajectories based on the detected operating state are predicted by the trained control agent, a trajectory performance value is determined for each of the test action trajectories by the performance evaluator, and the determined trajectory performance values are taken. The selected action trajectory is used to control the machine.

### CROSS-REFERENCE TO RELATED APPLICATIONS

This application is a national stage of PCT Application No. PCT/EP2023/079058, having a filing date of Oct. 18, 2023, which claims priority to EP Application Serial No. 22209688.5, having a filing date of Nov. 25, 2022, the entire contents both of which are hereby incorporated by reference.

### FIELD OF TECHNOLOGY

The following relates to a method and machine controller for controlling a machine.

### BACKGROUND

Data-driven machine learning methods are increasingly being used for controlling complex machines, such as e.g., robots, motors, manufacturing installations, factories, machine tools, milling machines, gas turbines, wind turbines, steam turbines, chemical reactors, cooling systems or heating systems. In this context, in particular, artificial neural networks are being trained by reinforcement learning methods to generate, for a respective state of the machine, a state-specific control action for controlling the machine which optimizes a performance of the machine. Such a control agent optimized for controlling a machine is often also referred to as policy, or as agent for short.

A successful optimization of a control agent generally requires large amounts of operating data of the machine to be controlled or of a structurally identical or similar machine as training data. In this case, the training data should cover the operating states and other operating conditions of the machine as representatively as possible.

In many cases, such training data are present in the form of databases in which operating data recorded on the machine are stored. Such stored training data are often also referred to as batch training data or offline training data. According to experience, training success generally depends on the extent to which the possible operating conditions of the machine are covered by the batch training data. Accordingly, it should be expected that control agents trained with batch training data exhibit unfavorable behavior in such operating states for which only few batch training data were available.

In order to improve the control behavior in areas of a state space that are not covered very much by training data, the publication “Overcoming Model Bias for Robust Offline Deep Reinforcement Learning” by Phillip Swazinna, Steffen Udluft and Thomas Runkler at https://arxiv.org/pdf/2008.05533 (retrieved on Apr. 14, 2022) proposes using dynamic models for performance evaluation. Even with this method, however, the resulting policies are often not unambiguously evaluatable or validatable in advance.

### SUMMARY

An aspect relates to a method and a machine controller for controlling a machine which allows more efficient and/or more reliable control.

This aspect is achieved by a method, by a machine controller, by a computer program product (non-transitory computer readable storage medium having instructions, which when executed by a processor, perform actions), and by a computer-readable storage medium.

For controlling a machine by a control agent, a multiplicity of training datasets are read in, each specifying in a manner assigned to one another a machine state, a control action and a subsequent state resulting from application of the control action to the machine state. Furthermore, for each of a multiplicity of the machine states:
with the aid of the training datasets a training action trajectory based on the respective machine state and specifying a temporal sequence of a plurality of control actions is determined;
by the control agent with the aid of the respective machine state an action trajectory based thereon is predicted; and
a deviation of the predicted action trajectory from the training action trajectory is determined.
   The deviation is accumulated here over a plurality of trajectory time steps.

The control agent is furthermore trained to reduce, in particular minimize, the determined deviations at least on average. Minimizing should in particular also be understood to mean approaching a minimum. Moreover, a performance evaluator is provided, which, with the aid of a machine state and an action trajectory, determines a trajectory performance value for controlling the machine by this action trajectory. For controlling the machine then
a current operating state of the machine is detected;
by the trained control agent a multiplicity of test action trajectories based on the detected operating state are generated;
for each of the test action trajectories a trajectory performance value is determined by the performance evaluator; and
depending on the determined trajectory performance values a performance-optimizing action trajectory is selected from the test action trajectories. The machine is controlled with the aid of the selected action trajectory.

A corresponding machine controller, a computer program product and a computer-readable, for example nonvolatile, storage medium is provided for performing the method according to embodiments of the invention.

The method according to embodiments of the invention and the machine controller according to embodiments of the invention can be performed and implemented for example by one or more computers, processors, application-specific integrated circuits (ASIC), digital signal processors (DSP) and/or so-called “field programmable gate arrays” (FPGA). Moreover, the method according to embodiments of the invention can be performed at least partly in a cloud and/or in an edge computing environment.

One advantage of embodiments of the invention can be seen in particular in the fact that the control, owing to taking account of entire trajectories of control actions, in many cases is less susceptible to a temporal accumulation of prediction errors. In the case of known controls, by contrast, a control agent, optionally in interaction with a transition model, is often trained to predict as accurately as possible only each next control action or each next subsequent state. In the case of many action sequences determined by iteratively performing these single-step methods, it can be observed, however, that prediction errors mount up, particularly in the case of unstable machine states. Reducing or minimizing deviations accumulated over trajectories enables such mounting up effects to be effectively reduced in many cases, particularly with relatively long time horizons.

The action trajectories predicted by a control agent trained according to embodiments of the invention thus in many cases reproduce a control behavior stored in the training data more accurately than a single-step method. This often effectively makes it possible to prevent the machine controller from operating in areas inadequately covered by the training data.

An advantage of embodiments of the invention can be seen in particular in the fact that the machine controller can be adapted to changing optimization or performance goals in a simple manner by way of corresponding adaptation of the performance evaluator. Retraining of the control agent, which is generally complex, is no longer required in many cases.

In accordance with one embodiment of the invention, the multiplicity of test action trajectories can be generated in such a way that the deviation thereof from an action trajectory predicted by the trained control agent does not exceed a predefined threshold value. This enables the selection of the performance-optimizing action trajectory to be restricted to action trajectories which do not differ overly from a control behavior stored in the training data. Impermissible or severely detrimental control actions can thus be effectively precluded in many cases.

Furthermore, a respective deviation of the generated test action trajectories from an action trajectory predicted by the trained control agent can be determined. A respective trajectory performance value can thus be modified, reduced, depending on the respectively determined deviation. In embodiments, a respective trajectory performance value can be reduced as the deviation increases. The performance-optimizing action trajectory can then be selected depending on the modified trajectory performance values. In this way, test action trajectories that deviate to a lesser extent from a control behavior stored in the training data can be in the selection of the performance-optimizing action trajectory.

Moreover, the multiplicity of test action trajectories can be generated by the trained control agent itself. Insofar as the control agent is trained to reproduce action trajectories determined from the training data, the generated test action trajectories should not differ overly from a control behavior stored in the training data.

According to an embodiment of the invention, for generating the test action trajectories a noise signal can be fed into the trained control agent. The noise signal fed in enables a random element to be introduced into the generation of the test action trajectories, which random element leads to an at least partly random-based variation or diversification of the generated test action trajectories. In this case, a variation range can be adjusted by controlling an amplitude of the noise signal. In this way, a control action space of the machine can be explored within predefinable limits.

In accordance with an embodiment of the invention, an individual control action can be performed at the beginning of the selected action trajectory at the machine. In embodiments, the method can then be continued with a subsequent operating state of the machine as current operating state, the subsequent operating state having been attained as a result of the individual control action having been performed. Thus, a predicted subsequent operating state of the machine can be replaced by an actually measured subsequent operating state, or a subsequent operating state that has been detected in some other way, and so a possible prediction error can be corrected as early as after the first step.

Furthermore, a first machine learning module, with the aid of the training data sets, can have been trained or be trained to predict, with the aid of a machine state and an action trajectory, a resulting state trajectory specifying a temporal sequence of a plurality of subsequent states. In this case, deviations accumulated over a plurality of time steps between predicted state trajectories and training state trajectories derived from the training datasets can be reduced, in particular minimized, at least on average. State trajectories predicted by the trained first machine learning module can then be used for predicting the predicted action trajectories and/or for generating the test action trajectories by the control agent.

The first machine learning module can comprise in particular a so-called transition model, which predicts a resulting subsequent state with the aid of a machine state and a control action. A subsequent state output by the transition model can then be fed into the control agent, which derives therefrom a subsequent control action to be applied in the subsequent state. The subsequent control action can be fed together with the subsequent state into the transition model again, which determines therefrom in turn a further subsequent state. The above actions can obviously be iterated in order finally to obtain a state trajectory comprising a plurality of subsequent states and an action trajectory comprising a plurality of control actions.

According to an embodiment of the invention, a respective training dataset can comprise an action performance value resulting from application of a respective control action to a respective machine state. Accordingly, the performance evaluator can comprise a second machine learning module, which, with the aid of the training datasets, is trained or has been trained to reproduce a resulting action performance value with the aid of a machine state and a control action. Such a second machine learning module is often also referred to in English as “reward prediction”. In practice, transition models are often also trained for “reward prediction”. In such a case, the first machine learning module can be identical with the second machine learning module.

In accordance with an embodiment of the invention, the performance evaluator can determine an action performance value for an individual control action at the end of a respective action trajectory. The action performance value, during the calculation of the trajectory performance value for the respective action trajectory, can then be allocated a higher weight than other action performance values of this action trajectory. In this way, in many cases it is possible to lessen an excessive increase in a prediction error, particularly in the case of action trajectories that are comparatively long and/or comprise a large time horizon. The above action performance value can be determined by a so-called temporal difference learning method, in particular by Q-learning.

### BRIEF DESCRIPTION

Some of the embodiments will be described in detail, with reference to the following figures, wherein like designations denote like members, wherein:

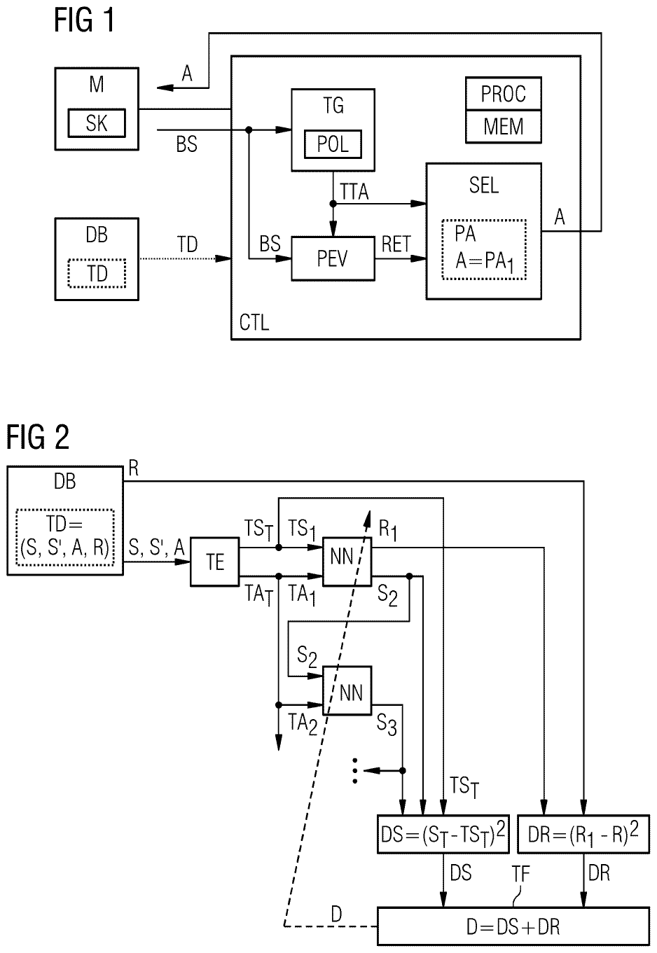

FIG. 1 illustrates a machine controller according to embodiments of the invention during control of a machine;

FIG. 2 illustrates training of a machine learning module for predicting subsequent states and performance values;

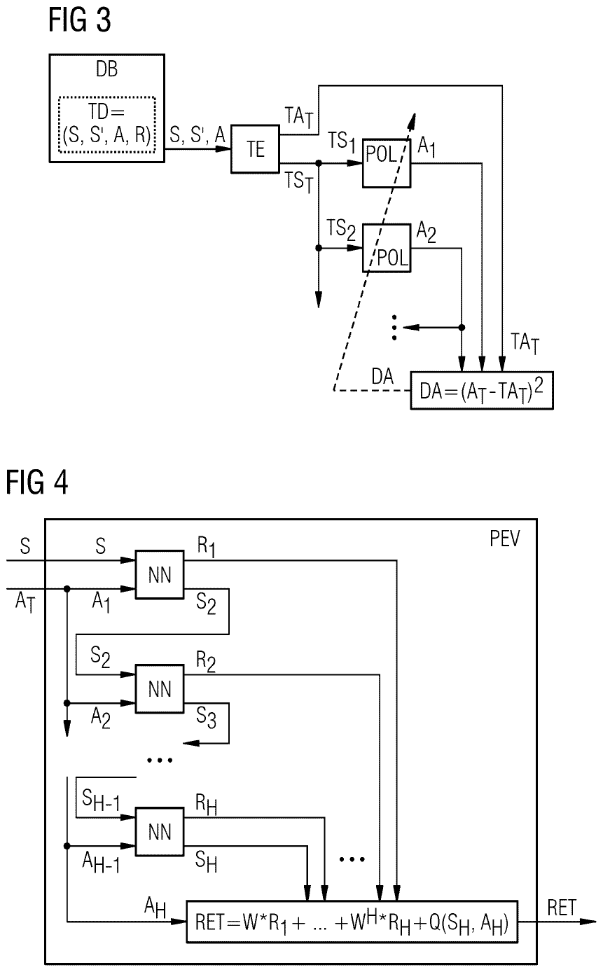

FIG. 3 illustrates training of the control agent for predicting control actions;

FIG. 4 illustrates a determination of a performance of an action trajectory; and

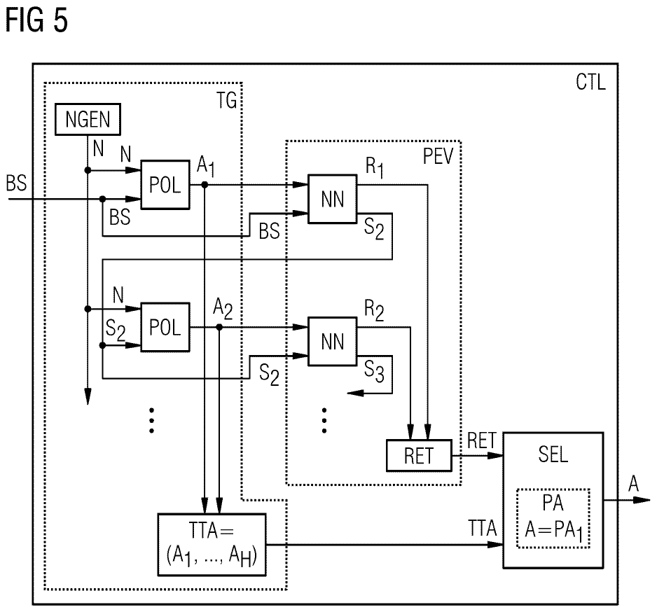

FIG. 5 illustrates a determination of a performance-optimizing action trajectory for controlling the machine.

Insofar as identical or corresponding reference signs are used in different figures, these reference signs denote the same or corresponding entities which can be implemented or configured in particular as described in association with the relevant figure.

### DETAILED DESCRIPTION

FIG. 1 illustrates a machine controller CTL according to embodiments of the invention during control of a machine M, e.g., a robot, a motor, a manufacturing installation, a factory, a machine tool, a milling machine, a gas turbine, a wind turbine, a steam turbine, a chemical reactor, a cooling system, a heating system or some other system. In embodiments, a component or a subsystem of a machine can also be interpreted as machine M.

The machine M has a sensor system SK for continuously detecting and/or measuring operating states of the machine M.

In FIG. 1, the machine controller CTL is illustrated externally to the machine M and is coupled thereto. Alternatively, the machine controller CTL can also be wholly or partly integrated into the machine M.

The machine controller CTL has one or more processors PROC for performing method steps of the machine controller CTL, and one or more memories MEM coupled to the processor PROC, for storing the data to be processed by the machine controller CTL.

Furthermore, the machine controller CTL comprises a trajectory generator TG for generating action trajectories. In this case, a respective action trajectory specifies a sequence of a plurality of successive control actions that can be carried out at the machine M, the sequence being based on a respective machine state of the machine M. A respective control action of an action trajectory is specified here by a respective action dataset. Such action datasets make it possible to specify in particular manipulated variables or changes in manipulated variables of the machine M, e.g., for performing a movement trajectory in the case of a robot or for adjusting a gas supply in the case of a gas turbine.

For generating the action trajectories, the trajectory generator TG comprises a learning-based control agent POL, which is trained or trainable in particular by supervised and/or reinforcement learning methods. Such a control agent is often also referred to as policy, or as agent for short. In the present exemplary embodiment, the control agent POL is implemented as an artificial neural network.

The control agent POL is trained beforehand with the aid of training data in such a way that action trajectories generated for a respectively predefined machine state, with the aid of the control agent, reproduce as accurately as possible a control behavior stored in the training data. A progression of this training is explained in greater detail below.

The training data can be recorded or measured and/or generated by simulation or in a data-driven manner at the machine M or at a machine similar thereto. In the present exemplary embodiment, the training data are taken from a database DB in which the training data are stored in the form of a large amount of training datasets TD.

Furthermore, the machine controller CTL has a learning-based performance evaluator PEV. The performance evaluator PEV serves the purpose of determining, with the aid of a machine state and an action trajectory, a trajectory performance value that quantifies a performance for controlling the machine M by this action trajectory. Here and hereinafter, a performance can relate in particular to an achievement, a yield, a speed, a weight, a running time, a precision, an error rate, a consumption of resources, an efficiency, an efficacy, pollutant emission, a stability, wear, a service life, a physical property, a mechanical property, an electrical property, a constraint to be complied with, or other target variables of the machine M or of one of the components thereof. Training of the performance evaluator PEV is explained in greater detail below.

Moreover, the machine controller CTL comprises a selection module SEL for selecting a performance-optimizing action trajectory. Optimizing should in particular also be understood to mean approaching an optimum.

After training has been completed, the trajectory generator TG, the performance evaluator PEV and the selection module SEL can be used for optimized control of the machine M. For this purpose, current operating states of the machine M are continuously measured by the sensor system SK, or determined in some other way, and are communicated in the form of state datasets BS from the machine M to the machine controller CTL. Alternatively or additionally, the state datasets BS can be determined by simulation at least partly by a simulator, in particular a digital twin of the machine M.

A state dataset, here in particular BS, specifies a machine state of the machine M, by way of a numerical state vector. Such state datasets can comprise measurement data, sensor data, ambient data or other data that arise during operation of the machine M or influence operation, in particular data regarding actuator positions, occurring forces, power, pressure, temperature, valve positions, emissions and/or resource consumption of the machine M or of one of the components thereof. In the case of production installations, the state datasets can also relate to a product quality or other product properties.

The state datasets BS communicated to the machine controller CTL are fed into the trajectory generator TG and into the trained performance evaluator PEV in each case as input data.

For a respectively supplied state dataset BS, the trajectory generator TG generates, by the trained control agent POL, a multiplicity of test action trajectories TTA based on the current operating state specified by the respective state dataset BS.

The generated test action trajectories TTA are communicated from the trajectory generator TG to the performance evaluator PEV and to the selection module SEL.

The performance evaluator PEV determines, for each of the communicated test action trajectories TTA, a trajectory performance value RET for controlling the machine M on the basis of the current operating state by the respective test action trajectory TTA. The performance evaluator PEV feeds the respectively determined trajectory performance values RET into the selection module SEL in a manner assigned to the respectively evaluated test action trajectory TTA.

With the aid of the trajectory performance values RET fed in, the selection module SEL then selects a performance-optimizing action trajectory PA from the multiplicity of test action trajectories TTA; that action trajectory to which a maximum trajectory performance value RET is assigned.

Furthermore, the selection module SEL selects an individual control action PA₁ at the beginning of the performance-optimizing action trajectory PA and communicates it in the form of an action dataset A to the machine M. The control action specified by the action dataset A is then performed by the machine M. In this way, the machine M is controlled in a manner optimized for the current operating state.

As a result of performing the specified control action, the machine M attains a subsequent operating state. The latter is in turn detected by the sensor system SK and communicated as new current operating state in the form of a new state dataset BS to the machine controller CTL. The control method described above is then continued iteratively with the new state dataset BS.

FIG. 2 illustrates training of a machine learning module NN for predicting subsequent states and performance values. The machine learning module NN is part of the performance evaluator PEV. In order to illustrate successive processing steps, a plurality of instances of the machine learning module NN are illustrated in FIGS. 2, 4 and 5. The different instances can correspond in particular to different calls or analyses of routines by which the machine learning module NN is implemented.

The machine learning module NN is trainable in a data-driven manner and is intended in particular to model a state transition upon application of a control action to a predefined machine state of the machine M. Such a machine learning module is often also referred to as a transition model or system model. In the present exemplary embodiment, the machine learning module NN is implemented as an artificial neural network, in particular as a neural feedforward network.

The machine learning module NN, with the aid of the training datasets TD contained in the database DB, is intended to be trained to predict, with the aid of a respective machine state and a respective control action, a subsequent state of the machine M resulting from application of the control action, and an action performance value resulting therefrom. The subsequent state is intended to be predicted in such a way that a state trajectory resulting from progressive prediction of succeeding subsequent states deviates as little as possible from a training state trajectory determined from the training data. Owing to entire state trajectories being taken into account, the predictions of the machine learning module NN trained in this way are in many cases less susceptible to a temporal accumulation of prediction errors.

Training should generally be understood to mean an optimization of a mapping of input data of a machine learning module, here the machine learning module NN or the control agent POL, onto the output data thereof. This mapping is optimized according to predefined learned and/or learnable criteria during a training phase. Criteria used can be, particularly in the case of prediction models, a prediction error and, in the case of control models, a success of a control action. The training makes it possible for example to adjust or optimize networking structures of neurons of a neural network and/or weights of connections between the neurons in such a way that the predefined criteria are satisfied as well as possible. The training can thus be regarded as an optimization problem. A large number of efficient optimization methods are available for such optimization problems in the field of machine learning, in particular gradient-based optimization methods, gradient-free optimization methods, backpropagation methods, particle swarm optimizations, genetic optimization methods and/or population-based optimization methods.

In embodiments, artificial neural networks, recurrent neural networks, convolutional neural networks, perceptrons, Bayesian neural networks, autoencoders, variational autoencoders, Gaussian processes, deep learning architectures, support vector machines, data-driven regression models, K nearest neighbor classifiers, physical models or decision trees can be trained in this way. Accordingly, the machine learning module NN and/or the control agent POL can also be implemented by one or more of the machine learning models presented above or can comprise one or more of such machine learning models.

In the present exemplary embodiment, a respective training dataset TD comprises a state dataset S, an action dataset A, a subsequent state dataset S′ and an action performance value R. As already mentioned above, the state datasets S each specify a machine state of the machine M and the action datasets A each specify a control action that can be carried out at the machine M in this machine state. Accordingly, a respective subsequent state dataset S′ specifies a subsequent state resulting from application of the respective control action to the respective machine state, i.e., specifies a machine state of the machine M that is adopted in a succeeding time step. Furthermore, the respectively associated action performance value R quantifies a respective performance in regard to performing the respective control action in the respective machine state. In the context of machine learning, such a performance value is also designated by the terms reward or—complementary thereto—loss or costs.

With the aid of the training datasets TD, a trajectory determination TE derives, for each of a multiplicity of state datasets S, a training state trajectory TS_{T} and a training action trajectory TA_{T} which are based on the respective state dataset S. The training trajectories TS_{T} and TA_{T} and also trajectories described below are each indexed by an index T that runs through the temporally successive steps 1, . . . , H. In this case, H indicates a length of the respective trajectory of e.g., 5, 10, 30, 50 or 100. In an embodiment, a value of at least 3 or at least 4 is chosen for H. Accordingly, the respective training state trajectory TS_{T} comprises the temporally successive state datasets TS₁, . . . , TS_{H} and the respective training action trajectory TA_{T} comprises the temporally successive action datasets TA₁, . . . , TA_{H}.

A respective training state trajectory TS_{T} can be derived by the trajectory determination TE in particular by virtue of the fact that, for the respective state dataset S, a subsequent state dataset S′ contained in the same training dataset TD is used to determine a subsequent training dataset containing a state dataset that follows this subsequent state dataset S′. The entire training state trajectory (TS₁, . . . , TS_{H}) can be derived by iteratively applying this procedure. Insofar as the training datasets that are run through in this way also contain associated action datasets, an associated action trajectory (TA₁, . . . , TA_{H}) can also be derived in this way.

For the training of the machine learning module NN, for a multiplicity of state datasets S and training trajectories TS_{T} and TA_{T} based thereon, the machine learning module NN is in each case supplied with a training state dataset TS₁ at the beginning of the respective training state trajectory TS_{T} and a training action dataset TA₁ at the beginning of the respective training action trajectory TA_{T}=(TA₁, TA₂, . . . , TA_{H}) as input data. For a respective pair (TS₁, TA₁) of input datasets, the machine learning module NN outputs an output dataset R₁ as predicted action performance value and an output dataset S₂ as predicted subsequent state dataset.

The predicted subsequent state dataset S₂ is then in turn fed together with the training action dataset TA₂ into the machine learning module NN, which derives therefrom a further predicted subsequent state dataset S₃ and a further predicted action performance value (not illustrated). The above procedure can obviously be iterated in order finally to obtain a state trajectory S_{T}=(S₁=TS₁, S₂, . . . , S_{H}) based on the respective training state dataset TS₁ and predicted by the machine learning module NN.

The training of the machine learning module NN endeavors to ensure that firstly the predicted state trajectories S_{T} deviate from the corresponding training state trajectories TS_{T} and secondly the predicted action performance values R₁ deviate from the corresponding action performance values R as little as possible at least on average.

For this purpose, firstly a respective deviation DS between a respective predicted state trajectory S_{T} and the respectively corresponding training state trajectory TS_{T} is determined. In this case, the deviation DS can be regarded as a reproduction error or prediction error.

In order to determine a respective deviation DS between the state trajectories S_{T} and TS_{T}, deviations between the individual state datasets Sₖ and TSₖ are accumulated over all the time steps k=1, . . . , H. In this case, a deviation between individual state datasets Sₖ and TSₖ can be determined in particular as a Euclidean distance ∥Sₖ−TSₖ∥₂ between the respective representing state vectors or as the square of the distance, (Sₖ−TSₖ)₂. This results for example in

$$DS = {\sum }_{k = 2}^{H} {( {S}_{k} - {TS}_{k} )}^{2} .$$

If the output of a subsequent state dataset Sₖ₊₁ is represented by the machine learning module NN as a function of a state dataset Sₖ and an action dataset Aₖ, in accordance with Sₖ₊₁=NN (Sₖ, Aₖ), this results in

$$DS = {\sum }_{k = 1}^{H - 1} {( NN ( {S}_{k} , {TA}_{k} ) - {TS}_{k + 1} )}^{2} .$$

Furthermore, a respective deviation DR between a predicted action performance value R₁ and a respectively corresponding action performance value R is determined, e.g., in accordance with DR=(R₁−R)². In this case, the deviation DR can also be regarded as a reproduction error or prediction error.

The respective deviations DS and DR are combined in a target function TF, which determines a respective target value D to be minimized by the training. In the context of machine learning, such a target function is often also referred to as a loss function or a cost function. In the present exemplary embodiment, the target value D is calculated as a sum of the deviations DS and DR in accordance with D=DS+DR. In some embodiments, the summands here can be suitably weighted. The respective target values D can be regarded as a combined prediction error of the machine learning module NN.

As indicated by a dashed arrow in FIG. 2, the respective target values D is fed back to the machine learning module NN. With the aid of the target values D fed back, the machine learning module NN is trained to minimize the target values D and thus the combined prediction error of the machine learning module NN at least on average. A large number of efficient optimization methods are available for minimizing the target values D.

As a result of the minimization of the target values D, the machine learning module NN is trained, with respect to a machine state and with the aid of a sequence of control actions, to predict a resulting state trajectory and a resulting action performance value as well as possible. Taking account of entire trajectories when ascertaining the deviations DS makes it possible in many cases for a mounting up of prediction errors to be effectively avoided or at least lessened.

FIG. 3 illustrates training of the control agent POL for predicting control actions. In order to illustrate successive processing steps, a plurality of instances of the control agent POL are illustrated in FIGS. 3 and 5. The different instances can correspond in particular to different calls or analyses of routines by which the control agent POL is implemented.

The control agent POL, with the aid of the training datasets TD contained in the database DB, is intended to be trained to predict, with the aid of a respective machine state, a respective control action that can be performed in this machine state. In this case, the respective control action is intended to be predicted in such a way that an action trajectory resulting from progressive application of succeeding control actions to subsequent states deviates as little as possible from a training action trajectory determined from the training data. Owing to entire action trajectories being taken into account, the predictions of the control agent POL trained in this way are in many cases less susceptible to a temporal accumulation of prediction errors.

As already described above, from the training datasets TD, the trajectory determination TE derives, for each of a multiplicity of state datasets S, a training state trajectory TS_{T} and a training action trajectory TA_{T} which are based on the respective state dataset S. In this case, the respective training state trajectory TS_{T} comprises the temporally successive state datasets TS₁, . . . , TS_{H} and the respective training action trajectory TA_{T} comprises the temporally successive action datasets TA₁, . . . , TA_{H}.

For the training of the control agent POL, for a multiplicity of state datasets S and training trajectories TS_{T} and TA_{T} based thereon, the control agent is in each case supplied with the training state datasets TSₖ, k=1, . . . , H of the respective training trajectory TS_{T} individually as input datasets. For a respective input dataset TSₖ, the control agent POL then outputs a respective output dataset Aₖ as a predicted action dataset. The predicted action datasets A₁, . . . , A_{H} evidently form a continuous predicted action trajectory A_{T}=(A₁, . . . , A_{H}).

The training of the control agent POL endeavors to ensure that the predicted action trajectories A_{T} deviate from the corresponding training action trajectories TA_{T} as little as possible at least on average.

For this purpose, a respective deviation DA between a respective predicted action trajectory A_{T} and the respectively corresponding training action trajectory TA_{T} is determined. In this case, the deviation DA can be regarded as a reproduction error or prediction error.

In order to determine a respective deviation DA between the action trajectories A_{T} and TA_{T}, deviations between the individual action datasets Aₖ and TAₖ are accumulated over all the time steps k=1, . . . , H. In this case, a deviation between individual action datasets Aₖ and TAₖ can be determined in particular as a Euclidean distance ∥Aₖ−TAₖ∥₂ between the respective representing state vectors or as the square of the distance, (Aₖ—TAₖ)² This results for example in

$$DA = {\sum }_{k = 1}^{H} {( {A}_{k} - {TA}_{k} )}^{2} .$$

If the output of an action dataset Aₖ is represented by the control agent POL as a function of a state dataset Sₖ, in accordance with Aₖ=POL(Sₖ), this results in

$$DA = {\sum }_{k = 1}^{H} {( POL ( {S}_{k} ) - {TA}_{k} )}^{2} .$$

In some embodiments, the control agent POL can additionally be supplied with an action dataset Aₖ₋₁ of a preceding control action as a further input dataset, such that Aₖ=POL(Sₖ, Aₖ₋₁). In this case, the deviation DA can be determined in accordance

$$DA = {\sum }_{k = 1}^{H} {( POL ( {S}_{k} , {A}_{k - 1} ) - {TA}_{k} )}^{2} .$$

Taking account of an earlier predicted action dataset makes it possible in many cases for a prediction accuracy of the control agent POL to be significantly increased.

As indicated by a dashed arrow in FIG. 3, the respective deviations DA are fed back to the control agent POL. With the aid of the deviations DA fed back, the control agent POL is trained to minimize the deviations DA and thus the prediction error of the control agent POL at least on average. A large number of efficient optimization methods are available for minimizing the deviations DA.

As a result of the minimization of the deviations DA, the control agent POL is trained to predict as well as possible an action trajectory based on a machine state. Taking account of entire trajectories when ascertaining the deviations DA makes it possible in many cases for a mounting up of prediction errors to be effectively avoided or at least lessened.

FIG. 4 illustrates a determination of a performance of an action trajectory A_{T} based on a machine state, by the performance evaluator PEV. The performance evaluator PEV comprises the machine learning module NN, which has been trained as described above. In order to evaluate the performance, a state dataset S specifying the machine state and the action trajectory A_{T} to be evaluated are fed into the performance evaluator PEV.

The state dataset S and an action dataset A₁ at the beginning of the action trajectory A_{T}=(A₁, A₂, . . . , A_{H}) are fed to the trained machine learning module NN as input datasets. From the input datasets S and A₁, the trained machine learning module NN derives an output dataset R₁ as a predicted action performance value and an output dataset S₂ as a predicted subsequent state dataset.

The predicted subsequent state dataset S₂ is then in turn fed together with the action dataset A₂ of the action trajectory A_{T} into the machine learning module NN, which derives therefrom a further predicted subsequent state dataset S₃ and a further predicted action performance value R₂. The above procedure can obviously be iterated in order finally to obtain a sequence of predicted action performance values R₁, . . . , R_{H} and a predicted subsequent state dataset S_{H} at the end of a progressively predicted state trajectory (S₁, . . . , S_{H}).

From the predicted action performance values R₁, . . . , R_{H}, the predicted subsequent state dataset S_{H} and the action dataset A_{H} at the end of the action trajectory A_{T}, the performance evaluator PEV finally determines a trajectory performance value RET for the entire action trajectory A_{T} based on the state dataset S.

For this purpose, in the present exemplary embodiment, the performance evaluator PEV calculates a weighted sum W*R₁+ . . . +W^{H}*R_{H} of the action performance values R₁, . . . , R_{H}, the weights of which with each time step into the future are multiplied by a discounting factor W<1. For example, a value of 0.99, 0.95 or 0.9 can be used for the discounting factor W.

In addition to the weighted sum W*R₁+ . . . +W^{H}*R_{H}, the performance evaluator PEV determines a separate action performance value Q for the end of the action trajectory A_{T}. The separate action performance value Q is calculated from the action dataset A_{H} and the predicted subsequent state dataset S_{H} and added to the weighted sum W*R₁+ . . . +W^{H}*R_{H}, the separate action performance value Q being allocated a higher weight than the action performance values R₁, . . . , R_{H}.

In this way, in many cases it is possible to lessen an excessive increase in a prediction error, particularly in the case of action trajectories that are comparatively long and/or comprise a large time horizon. The separate action performance value Q can be determined by a so-called temporal difference learning method, in particular by Q-learning.

The trajectory performance value thus results as RET=W*R₁+ . . . +W^{H}*R_{H}+Q(S_{H}, A_{H}).

The trajectory performance value RET quantifies a performance of the machine M accumulated over a plurality of time steps into the future, while taking particular account of the end of the evaluated action trajectory A_{T}. In the technical sphere of machine learning, in particular reinforcement learning, such an overall performance is often also referred to as “return”.

The predicted overall performance RET is finally output as the evaluation result by the performance evaluator PEV.

FIG. 5 illustrates a determination of a performance-optimizing action trajectory PA for a detected operating state of the machine M, by the machine controller CTL. The machine controller CTL comprises the trajectory generator TG with the trained control agent POL, the performance evaluator PEV with the trained machine learning module NN, and the selection module SEL. The control agent POL and the machine learning module NN have each been trained as described above.

In order to determine the performance-optimizing action trajectory PA, firstly an operating state dataset BS specifying the detected operating state is fed into the machine controller CTL. With the aid of the operating state dataset BS, a multiplicity of test action trajectories TTA which are based on this operating state are intended to be generated by the trained control agent POL and the trained machine learning module NN. For this purpose, the operating state dataset BS is fed to the trained control agent POL and to the trained machine learning module NN as a respective input dataset.

For the variation or diversification of the test action trajectories TTA to be generated, the trajectory generator TG has an adjustable noise generator NGEN, which generates a noise signal N. The noise signal N is likewise fed into the trained control agent POL in order to influence the prediction of action datasets by the trained control agent POL in a randomly based manner. A variation range of the predicted action datasets can be adjusted in a simple manner by control of an amplitude or optionally other properties of the noise signal N. The amplitude is adjusted such that the prediction is only comparatively slightly influenced.

For the operating state dataset BS fed in, a predicted action dataset A₁ is output by the trained control agent POL under the influence of the noise signal N. The predicted action dataset A₁ is fed together with the operating state dataset BS to the trained machine learning module NN, which predicts therefrom an action performance value R₁ and a subsequent state dataset S₂. The predicted subsequent state dataset S₂ is then in turn fed into the trained control agent POL, which derives therefrom a further action dataset A₂ under the influence of the noise signal N. The further action dataset is fed together with the predicted subsequent state dataset S₂ again to the trained machine learning module NN, which predicts therefrom a further action performance value R₂ and a further subsequent state dataset S₃. The above process can obviously be iterated in order finally to obtain a predicted test action trajectory TTA=(A₁, A₂, . . . , A_{H}) based on the operating state, and an assigned sequence of predicted action performance values R₁, R₂, . . . , R_{H}.

From the predicted action performance values R₁, R₂, . . . , R_{H}, a trajectory performance value RET for the assigned test action trajectory TTA is determined by the performance evaluator PEV, as described in association with FIG. 4.

The above procedure is repeated many times in order thus to obtain a multiplicity of randomly varied test action trajectories TTA based on the detected operating state, in each case together with an assigned trajectory performance value RET.

Alternatively or additionally, the test action trajectories TTA can also be generated by a space of control actions being searched systematically and/or in a randomly influenced manner for test action trajectories which deviate only little from action trajectories generated by the trained control agent POL. Random influencing of the trained control agent POL can generally be dispensed with in such cases. Such a search can be carried out, for example, in the context of population-based optimization methods.

The generated test action trajectories TTA and the respectively assigned trajectory performance values RET are fed into the selection module SEL. Then, as described in association with FIG. 1, the selection module SEL selects a performance-optimizing action trajectory PA from the test action trajectory TTA. The first action dataset PA₁ of the performance-optimizing action trajectory PA is finally communicated to the machine M in order to control the latter in a manner optimized for the detected current operating state.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for controlling a machine by a control agent, wherein
a) a multiplicity of training datasets are read in, each specifying in a manner assigned to one another a machine state, a control action and a subsequent state resulting from application of the control action to the machine state;
b) for each of a multiplicity of the machine states
with the aid of the training datasets a training action trajectory based on the respective machine state and specifying a temporal sequence of a plurality of control actions is determined,
by the control agent with the aid of the respective machine state an action trajectory based thereon is predicted; and
a deviation of the predicted action trajectory from the training action trajectory is determined, wherein the deviation is accumulated over a plurality of trajectory time steps;
c) the control agent is trained to reduce the determined deviations at least on average;
d) a performance evaluator is provided, which, with the aid of a machine state and an action trajectory, determines a trajectory performance value for controlling the machine by this action trajectory;
e) for controlling the machine
a current operating state of the machine is detected;
by the trained control agent a multiplicity of test action trajectories based on the detected operating state are generated;
for each of the test action trajectories a trajectory performance value is determined by the performance evaluator; and
depending on the determined trajectory performance values a performance-optimizing action trajectory is selected from the test action trajectories; and
f) the machine is controlled with the aid of the selected action trajectory.

2. The method as claimed in claim 1, wherein
in that the multiplicity of test action trajectories are generated in such a way that the deviation thereof from an action trajectory predicted by the trained control agent does not exceed a predefined threshold value.

3. The method as claimed in claim 1, wherein
in that a respective deviation of the generated test action trajectories from an action trajectory predicted by the trained control agent is determined;
in that a respective trajectory performance value is modified depending on the respectively determined deviation; and
in that the performance-optimizing action trajectory is selected depending on the modified trajectory performance values.

4. The method as claimed in claim 1, wherein
in that the multiplicity of test action trajectories are generated by the trained control agent.

5. The method as claimed in claim 1, wherein
in that for generating the test action trajectories a noise signal is fed into the trained control agent.

6. The method as claimed in claim 1, wherein
in that an individual control action is performed at the beginning of the selected action trajectory at the machine; and
in that the method is continued with a subsequent operating state of the machine as current operating state, the subsequent operating state having been attained as a result of the individual control action having been performed.

7. The method as claimed in claim 1, wherein
in that a first machine learning module, with the aid of the training datasets, has been trained or is trained to predict, with the aid of a machine state and an action trajectory, a resulting state trajectory specifying a temporal sequence of a plurality of subsequent states, wherein deviations accumulated over a plurality of time steps between predicted state trajectories and training state trajectories derived from the training datasets are reduced at least on average; and
in that state trajectories predicted by the trained first machine learning module are used for predicting the predicted action trajectories and/or for generating the test action trajectories by the control agent.

8. The method as claimed in claim 1, wherein
in that one or more subsequent states are fed to the control agent for predicting the predicted action trajectories and/or for generating the test action trajectories.

9. The method as claimed in claim 1, wherein
in that a respective training dataset comprises an action performance value resulting from application of a respective control action to a respective machine state; and
in that the performance evaluator comprises a second machine learning module, which, with the aid of the training datasets, has been trained or is trained to reproduce a resulting action performance value with the aid of a machine state and a control action.

10. The method as claimed in claim 1, wherein
in that the performance evaluator determines an action performance value for an individual control action at the end of a respective action trajectory; and
in that this action performance value, during the calculation of the trajectory performance value for the respective action trajectory, is allocated a higher weight than other action performance values of this action trajectory.

11. A machine controller for controlling a machine, comprising means for performing the steps of a method as claimed in claim 1.

12. A computer program product, comprising a computer readable hardware storage device having computer readable program code stored therein, the program code executable by a processor of a computer system to implement a method, comprising instructions which, when the program code is executed by a computer, cause the latter to perform a method as claimed in claim 1.

13. A computer-readable storage medium comprising a computer program product as claimed in claim 12.
